(19) United States
(12) Patent Application Publication
(10) Pub. No.: US 2017/0010185 A1
(43) Pub. Date: Jan. 12, 2017

(54) TIRE HEALTH MONITORING SYSTEM

(71) Applicant: Caterpillar Inc., Peoria, IL (US)

(72) Inventor: Kristopher Eric Shaffer, Dunlap, IL (US)

(73) Assignee: Caterpillar Inc., Peoria, IL (US)

(21) Appl. No.: 15/270,317

(22) Filed: Sep. 20, 2016

(51) Int. Cl. G01M 17/02; G06F 3/0484; G01L 1/24; B60C 25/00; B60C 25/05

(52) U.S. Cl. CPC G01M 17/027; B60C 25/002; B60C 25/0554; G01L 1/242; G06F 3/0484

(57) ABSTRACT

A health monitoring system for a tire is provided. The health monitoring system includes a fiber optic strain sensor array. The fiber optic strain sensor array is configured to generate data indicative of a strain in the tire. The fiber optic strain sensor array is arranged and aligned within a fibrous reinforcement array of the tire to generate data which can be directly correlated to an interaction of the tire and a work surface on which the tire operates. The health monitoring system also includes a control module. The control module is configured to receive the data associated with the strain and the interaction of the tire. The control module is also configured to generate visual representation of the tire based on the received data of the strain in the tire and the interaction of the tire for indicating an effect of operating the tire on the work surface.

### TECHNICAL FIELD

The present disclosure relates to a real-time telemetry monitoring system, and more particularly to the system for monitoring a complete condition of a tire.

### BACKGROUND

Machines, such as those used in construction environments, operate on surfaces that have variable characteristics. For example, the machines may operate on uneven surfaces, such as, rocky terrains. Tires that provide mobility to the machines on such surfaces may undergo excessive wear and tear over a duration of time. Frequent replacement or maintenance of the tires may lead to an increase in machine owning and operating costs.

Current systems use pressure sensors and temperature sensors to monitor pressure and temperatures of the tires, respectively. For example, Tire-Pressure Monitoring Systems (TPMS) and similar technologies are used to monitor pressure and temperature of the tires. Further, optical tire monitoring systems monitor visible conditions of the tires. However, these systems do not take into account effects of external factors, such as, environment or characteristics of the surface on which the tires operate. Such external factors and their effects on the tires may contribute in reducing service life of the tires, in turn affecting productivity and increase in overall operating costs.

U.S. Pat. No. 7,233,850 describes a vehicle steering apparatus that detects tire load, and based on the detected tire load, performs steering control which accurately reflects the road conditions. A vehicle steering apparatus of the present invention includes a control unit, which controls a steering actuator in accordance with the operation of a steering wheel. An operation reaction force generated by a reaction force actuator is applied to the steering wheel. Within the tire, stress sensors and an air pressure sensor are provided. The control unit controls the steering actuator and the reaction force actuator with referring to the tire load detected by these sensors.

### SUMMARY OF THE DISCLOSURE

In one aspect of the present disclosure, a health monitoring system for a tire is provided. The health monitoring system includes a fiber optic strain sensor array associated with the tire. The fiber optic strain sensor array is configured to generate data indicative of a strain in the tire. The fiber optic strain sensor array is arranged and aligned within a fibrous reinforcement array of the tire in such a manner that the fiber optic strain sensor array is capable to generate data which can be directly correlated to an interaction of the tire and a work surface on which the tire operates. The health monitoring system also includes a control module communicably coupled to the fiber optic strain sensor array. The control module is configured to receive the data associated with the strain and the interaction of the tire from the fiber optic strain sensor array. The control module is also configured to generate visual representation of the tire based on the received data of the strain in the tire and the interaction of the tire for indicating an effect of operating the tire on the work surface.

Other features and aspects of this disclosure will be apparent from the following description and the accompanying drawings.

### BRIEF DESCRIPTION OF THE DRAWINGS

FIG. 1 is a perspective view of an exemplary machine having tires, according to various concepts of the present disclosure;

FIG. 2 is a schematic representation of the tire associated with the machine of FIG. 1, according to various concepts of the present disclosure;

FIG. 3 is a schematic representation of a fiber optical strain sensor array cast within a parent material of the tire associated with the machine of FIG. 1, according to various concepts of the present disclosure.

FIG. 4 is a block diagram of a health monitoring system for the tire of the machine of FIG. 1, according to the concepts of the present disclosure;

FIG. 5 is a diagrammatic representation of an output provided by the health monitoring system of FIG. 4, according to various concepts of the present disclosure; and

FIG. 6 is a diagrammatic representation of another type of output provided by the health monitoring system of FIG. 4, according to the concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

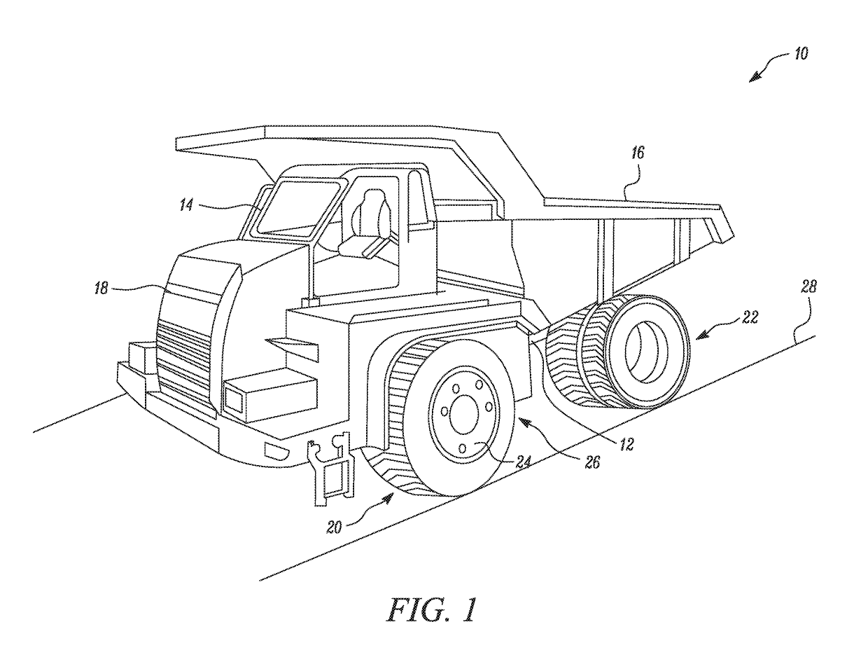

FIG. 1 illustrates an exemplary machine 10. The machine 10 may perform different tasks on a worksite. For example, the machine 10 may be used to transport material from one location to another on the worksite, The machine 10 may include, but not limited to, a mining truck, a haul truck, an on-highway truck, an off-highway truck, an articulated truck. Alternatively, the machine 10 may embody a loading machine that unloads payload onto another machine. In such an example, the machine 10 may include, but not limited to, a large wheel loader, a track-type loader, a shovel, and a crane.

As shown in FIG. the machine 10 is an off-highway truck. However, the concepts of the present disclosure may be embodied in a different type of machine. The machine 10 includes a frame 12. An operator cabin 14 is mounted on the frame 12 of the machine 10. The machine 10 also includes a load carrier 16 for carrying payload. Further, an enclosure 18 may be mounted on the frame 12. A power source (not shown) is positioned within the enclosure 18. The power source may generate mechanical, electric, or hydraulic power to propel the machine 10. In one example, the power source may embody an engine. The machine 10 also includes a powertrain (not shown)supported on the frame 12. The powertrain is coupled to the power source, according to specific powertrain features.

The machine 10 also includes a number of tires and rims of which two sets of tires and rims 20, 22 are shown in the accompanying figures. The tires and rims 20, 22 of the machine 10 are axially coupled with the powertrain. It should be noted that the number of tires and rims shown in the accompanying figures are exemplary in nature and may vary based on type of operation performed by the machine 10. For exemplary purposes, the present disclosure will be described with respect to the tire and rim 20. However, it should be noted that the description provided is equally applicable to other tires and rims of the machine 10.

The tire and rim 20 includes a hub 24 connected to the powertrain. The tire and rim 20 further includes a tire 26 connected to the hub 24. The tire 26 is a ground engaging member of the machine 10. The tire 26 may provide a desired amount of traction and cushioning between the machine 10 and a work surface 28. The work surface 28 may embody any one of a ground at a construction worksite, a roadway, etc., without any limitations. The tire 26 may support the machine 10 in a loaded, partially loaded, and empty condition, so that a desired amount of traction and/or cushioning is provided, regardless of the payload present on the machine 10. The tire 26 may be manufactured by any suitable manufacturing method known in the art. The tire 26 can include a bias type of tire, radial or bias-belted type of tire, steel belted type of tire, non-pneumatic urethane compression tire, non-pneumatic urethane tensile tire, etc., without any limitations.

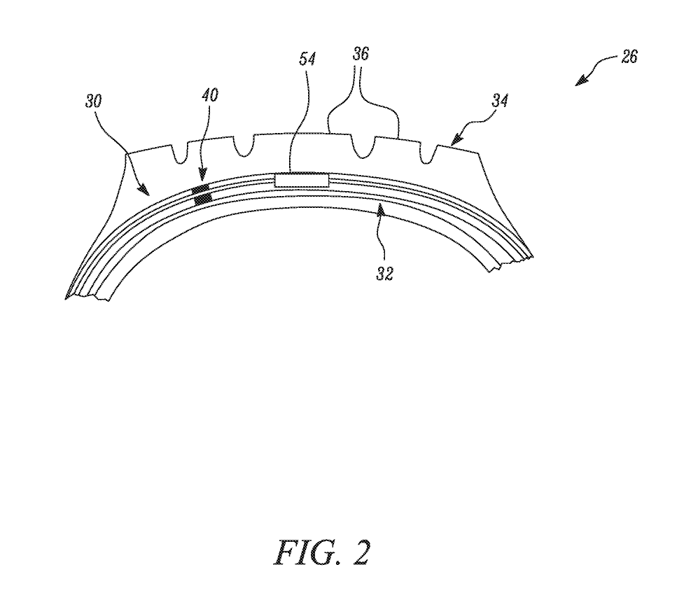

Referring to FIG. 2, the tire 26 includes cords 30 that provide the tensile strength necessary to contain inflation pressure. The cords 30 include a number of yams or strands that form a fibrous reinforcement array 32. The fibrous reinforcement array 32 may include strands made of steel, natural fibers, or synthetic fibers, without any limitations.

As shown in FIGS. 1 and 2, the tire 26 includes an elastomer 34 that includes a number of treads 36. The elastomer 34 encases the cords 30 to protect them from abrasion and hold them in place. The treads 36 are supported on an outer surface of a tire body. The treads 36 improve traction of the tire 26 at an interface between the tire 26 and the work surface 28 across which the tire 26 rolls.

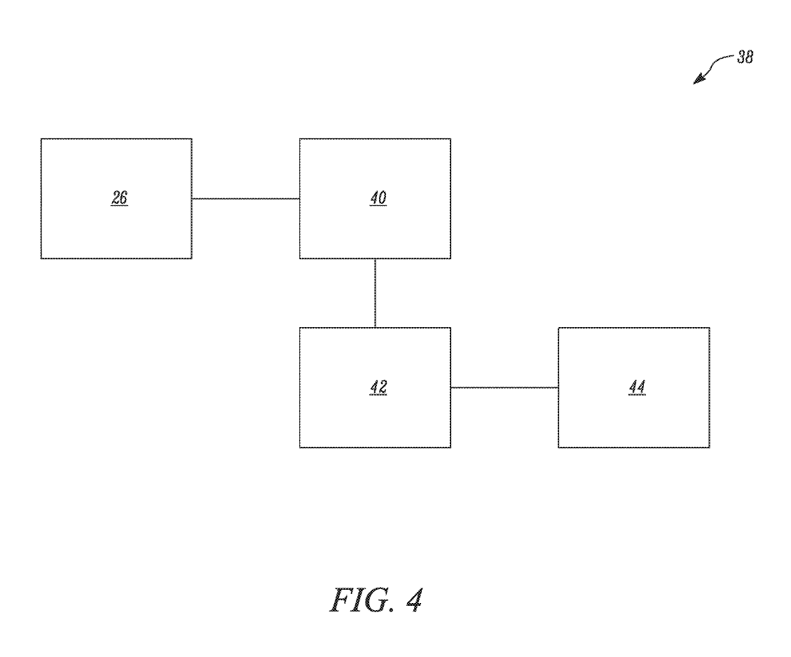

The present disclosure relates to a health monitoring system 38 (see FIG. 4) associated with the tire 26. The health monitoring system 38 is embodied as a real-time telemetry monitoring system. Referring to FIG. 4, the health monitoring system 38 monitors a complete condition of the tire 26 and indicates to an operator of the machine 10 or a maintenance personnel regarding an effect of operating the tire 26 on the work surface 28. The health monitoring system 38 will be explained in relation to the tire 26. However, it should be noted that the health monitoring system 38 monitors a condition of all the tires associated with the machine 10, without any limitations.

Referring to FIGS. 2, 3, and 4, the health monitoring system 38 includes a fiber optic strain sensor array 40. Further, the fiber optic strain sensor array 40 includes a known in the art intrinsic fiber optic strain sensor array that includes a number of optical fibers as the sensing element, without limiting the scope of the present disclosure. The fiber optic strain sensor array 40 is coupled to the tire 26 such that the fiber optic strain sensor array 40 does not misalign or displace during machine operation.

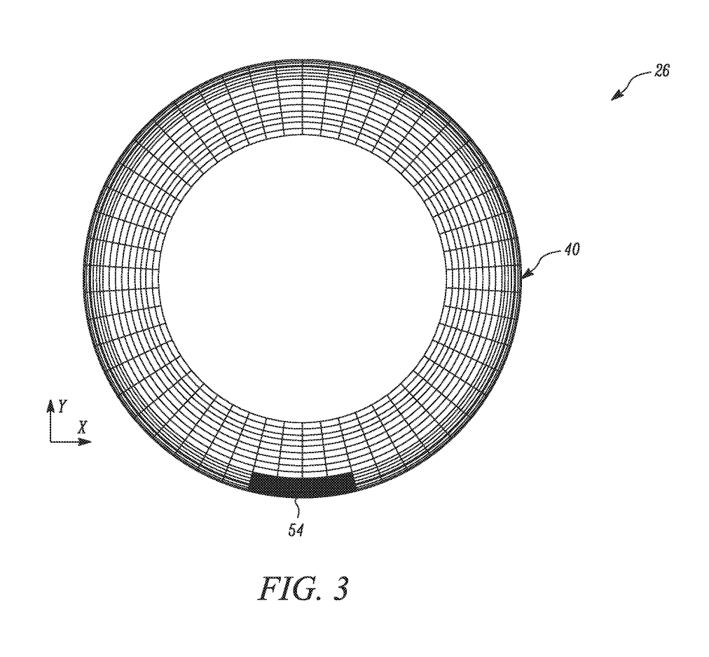

As shown in FIG. 3, the fiber optic strain sensor array 40 is positioned within the fibrous reinforcement array 32 of the tire 26. More particularly, the fiber optic strain sensor array 40 is arranged and aligned within the fibrous reinforcement array 32 of the tire 26. In one example, the fiber optic strain sensor array 40 is cast within a parent material of the tire 26 simultaneously aside the fibrous reinforcement array 32 at the time of fabrication of the tire 26, without any limitations. The fiber optic strain sensor array 40 may also be arranged within the fibrous reinforcement array 32 using any known coupling technique known in the art.

Referring to FIG. 2, the health monitoring system 38 also includes a sensor module 54. The sensor module 54 is communicably coupled to the fiber optic strain sensor array 40 and receives signals therefrom. For illustrative purposes, a single fiber optic strain sensor module 54 and a single fiber optic strain sensor array 40 is shown in the accompanying figures. However, the health monitoring system 38 may include a number of fiber optic strain sensor modules or strain sensor arrays. A total number of the fiber optic strain sensor modules or strain sensor arrays may vary based on a size of the tire 26. More particularly, a greater number of fiber optic strain sensor arrays are provided for larger sized diameters of the tire 26. The number of fiber optic strain sensor arrays may be equidistantly spaced along a periphery of the tire 26. In one example, a distance between two adjacent fiber optic strain sensor arrays may be approximately equal to 5 mm. Further, a smaller distance between two adjacent fiber optic strain sensor arrays will result in a higher resolution output, whereas a greater distance between two adjacent fiber optic strain sensor arrays will result in a lower resolution output.

The fiber optic strain sensor array 40 of the health monitoring system 38 generates data indicative of a strain in the tire 26. The data indicative of the strain in the tire 26 may be a numerical value of an amount of the strain that the tire 26 is being subjected to during operation of the machine 10 which could be directly correlated to pneumatic pressure within the tire 26. The fiber optic strain sensor array 40 may also measure temperature and other variables within the tire 26 by utilizing a known in the art variation of lite wavelength, color, and intensity.

Further, the fiber optic strain sensor array 40 also generates data indicative of an interaction of the tire 26 and the work surface 28 on which the tire 26 operates. More particularly, the fiber optic strain sensor array 40 generates the data which can be directly correlated to the interaction of the tire 26 and the work surface 28 on which the tire 26 operates. The data indicative of the interaction of the tire 26 and the work surface 28 may include data corresponding to an excessive deformation in the tire 26 based on conditions of the work surface 28. For example, when the tire 26 comes in contact with an obstacle on the work surface 28, a portion of the tire 26 may deform due to forces experienced by the tire 26 in a radial direction. The fiber optic strain sensor array 40 may detect this deformation in the radial direction of the tire 26.

Further, the fiber optic strain sensor array 40 may also detect the deformation of the tire 26 caused due to conditions of the work surface 28 on which the tire 26 is operating. For example, the work surface 28 may include uneven surfaces, such as, a rocky terrain. The fiber optic strain sensor array 40 may further detect traction forces on the tire 26 during operation Further, in some examples, the fiber optic strain sensor array 40 may generate data that can be used to calculate road friction coefficient.

The fiber optic strain sensor array 40 measures the data corresponding to the strain in the tire 26 or the interaction of the tire 26 and the work surface 28, and transmit the same to the sensor module 54. It should be noted that the fiber optic strain sensor array 40 may generate the data corresponding to the strain in the time 26 or the interaction of the tire 26 and the work surface 28 by modifying the fiber optic strain sensor array 40 so that a quantity to be measured modulates the intensity, phase, polarization, wavelength or transit time of light in the optical fiber.

The health monitoring system 38 also includes a control module 42. The control module 42 is embodied as a receiving/transmitting control module that is communicably coupled to the fiber optic strain sensor array 40. The control module 42 is capable of receiving and processing the data received from the fiber optic strain sensor array 40. More particularly, the control module 42 receives the data associated with the strain and/or the interaction of the tire 26 with the work surface 28 from the sensor module 54.

Based on the received data of the strain in the tire 26 and the interaction of the tire 26, the control module 42 generates a visual representation of the tire 26 for indicating an effect of operating the tire 26 on the work surface 8. In the illustrated example, the control module 42 generates a real-time wire frame representation of the tire 26 for indicating the effect of operating the tire 26 on the work surface 28.

The control module 42 is communicably coupled to an output module 44. In one example, the output module 44 is present in the operator cabin 14 of the machine 10. The wire frame representation of the tire 26 is displayed on an X-Y co-ordinate system on the output module 44. The wire frame representation of the tire 26 may indicate the strain on the tire 26 or the interaction of the tire 26 with the work surface 28, In another example, the output module 44 could be present or mirrored within a condition monitoring control center (not shown) where an outside monitoring personnel could identify and remediate conditions affecting tire health. In yet another example, the output module 44 could be fully automated and may transmit the data for performing actions necessary to remediate conditions affecting tire health.

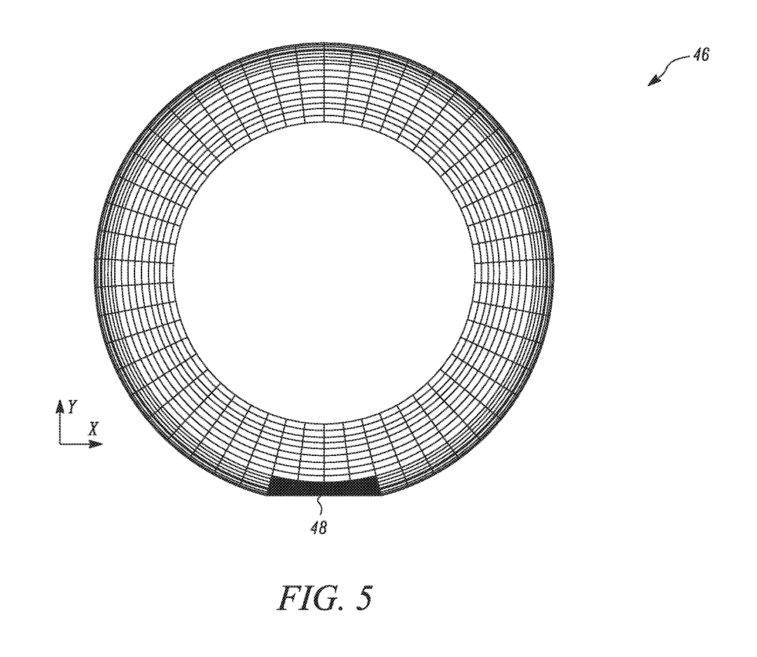

FIG. 5 is a diagrammatic representation of an exemplary output provided by the health monitoring system 38 when the tire 26 is subjected to a certain amount of strain during operation. In the illustrated example, the output is a wire frame model 46 of the tire 26 showing a work surface contact portion 48 of the tire 26 which is subjected to a larger strain and normal baseline deformation, as compared to other portions of the tire 26. More particularly, the control module 42 may utilize a multi-axis fiber optic sensor array strain coordinate data to identify intersecting strain and allow the wire frame model 46 to represent the shape of the tire 26 in real-time. The control module 42 may divide the wire frame model 46 of the tire 26 into a number of portions, and highlight the portion that is subjected to relatively more strain. Alternately, the control module 42 may smooth the wire frame representation of the tire 26 into a solid-model, and highlight the portion that is subjected to relatively more strain in a manner similar to Finite Element Analysis software, The strain experienced by the tire 26 may he higher where the tire 26 contacts the work surface 28. In another example, the wire frame model 46 may indicate the strain experienced by each portion of the tire 26 based on the signals received from the various fiber optic strain sensor arrays associated with the system 38.

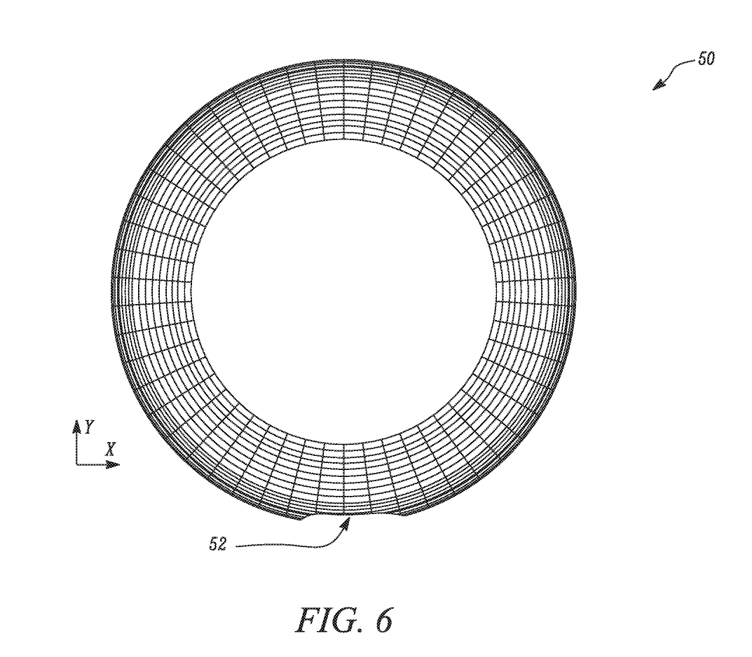

FIG. 6 is a diagrammatic representation of another exemplary output provided by the health monitoring system 38 to indicate the interaction of the tire 26 with the work surface 28. The output is a wire frame model 50 of the tire 26 showing a portion 52 of the tire 26 in an abnormally deformed state. The abnormal deformation may he a result of the impact of the tire 26 with an obstacle present on the work surface 28. In another example, the deformation may be caused by the characteristics of the work surface 28 on which the tire 26 operates, without any limitations.

In other examples, the output provided by the health monitoring system 38 may include text notifications that indicate to the operator, outside monitoring personnel, or autonomous software, etc. regarding the strain on the tire 26 or the interaction of the tire 26 with the work surface 28. For example, the output module 44 may display a value of the strain that the tire 26 is being subjected to. Further, the output module 44 may also generate a sound alarm if the strain on the tire 26 exceeds a predetermined threshold of strain. In another example, the output module 44 may display a value by which the tire 26 has displaced in the radial direction, due to the impact of the tire 26 with the obstacle. Alternatively, the output module 44 may generate a sound alarm to indicate the operator that the deformation in the tire 26 has exceeded a predetermined threshold.

### INDUSTRIAL APPLICABILITY

The present disclosure relates to the tire health monitoring system 38, the application of which may be extended to any vehicle with tires of a size and composition suitable to carry the fiber optic strain sensor array 40. This section will now be explained in relation to the tire 26 of the tire and rim 20. However, it should be noted that the description provided below is equally applicable to all the tires of the machine 10. The health monitoring system 38 allows accurate and reliable real-time monitoring of the health and life of the tire 26 of the machine 10. The health monitoring system 38 provides a real-time, wire frame representation of the tire 26 for the operator, outside monitoring personnel, or autonomous software, etc, to monitor and thus notify the operator or autonomous controller of any undesirable conditions during machine operation.

Further, the health monitoring system 38 of the present disclosure allows monitoring of the interaction of the tire 26 with the work surface 28. Thus, the operator, outside monitoring personnel, or autonomous software, etc. is made aware of the effects of external factors, such as, environment or characteristics of the work surface 28 on which the tire 26 operate. Thus, the operator, outside monitoring personnel, or autonomous software, etc. can remediate or improve undesirable conditions to extend the service life of the tire 26 as makes practical economic sense with factoring overall owning and operating costs.

Real-time monitoring of the interaction of the tire 26 with the work surface 28 would enable rapid identification and remediation of road-surface hazards which would otherwise lead to increased owning and operating costs. In one example, the real-time monitoring could include improving the work surface 28 to remove large obstacles and to improve overall surface conditions, in another example, the real-time monitoring could include optical monitoring of the ground or work surface to identify precise location of necessary ground or work surface repairs, thus preventing damage to additional tires of the machine 10 or the tires of other machines operating on the same ground or work surface, without limiting the scope of the present disclosure.

The output provided by the health monitoring system 38 can he used to determine wear or strain in the tire 26 and improve an expected service life of the tire 26 based on the effect of the operating environment on the tire 26. This strain may be a result of excessive loading on the machine 10 or on the tire 26, misalignment in the tire 26, etc. Thus, the operator, outside monitoring personnel, or autonomous software, etc. is made aware of such undesirable operating conditions that may require immediate remediation, as such operating conditions tend to reduce service life of the tire 26. The operator, outside monitoring personnel, or autonomous software, etc. can modify operating parameters to extend the service life of the tire 26 as makes practical economic sense with factoring overall owning and operating costs.

As the health monitoring system 38 allows early indication of tire health and expected life of the tire 26. The operator, outside monitoring personnel, or autonomous software, etc. can schedule downtime to either replace or refurbish the tire 26 to coincide with other planned maintenance procedures, such as the changing of engine oil and filters, in order to avoid additional or redundant downtime. Further, the data corresponding to the strain and interaction of the tire 26 with the work surface 28 may also be used in a predictive control framework to improve design of the tire 26. The output of the health monitoring system 38 can help the operator, outside monitoring personnel, or autonomous software, etc. to understand the conditions of the work surface 28, and thereby improve their operating techniques for improved performance and safety.

Further, the health monitoring system 38 includes the fiber optic strain sensor array 40. In some examples, the health monitoring system 38 may include other types of sensors that monitor the strain in the tire 26 and/or the interaction of the tire 26 with the work surface 28. For example, the health monitoring system 38 may include strain gauges that are coupled to the fibrous reinforcement array 32 of the tire 26 using Microelectromechanical Systems (MEMS) to attach or embed the optical fibers within the tire 26, without limiting the scope of the present disclosure.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A health monitoring system for a tire, the health monitoring system comprising:
a fiber optic strain sensor array associated with the tire, the fiber optic strain sensor array configured to generate data indicative of a strain in the tire, wherein the fiber optic strain sensor array is arranged and aligned within a fibrous reinforcement array of the tire in such a manner that the fiber optic strain sensor array is further configured to generate data which can be directly correlated to an interaction of the tire and a work surface on which the tire operates; and
a control module communicably coupled to the fiber optic strain sensor array, the control module configured to:
receive the data associated with the strain and the interaction of the tire from the fiber optic strain sensor array; and
generate a visual representation of the tire based on the received data of the strain in the tire and the interaction of the tire for indicating an effect of operating the tire on the work surface.

2. The health monitoring system of claim 1, wherein the fiber optic strain sensor array is cast within a parent material of the tire during a fabrication process of the tire.
